(19) United States
(12) Patent Application Publication
(10) Pub. No.: US 2006/0109249 A1
(43) Pub. Date: May 25, 2006

(54) Electronic device having a multi-functional pointing device of a track ball

(75) Inventors: Yun-Shian Lin, Taipei (TW); Ming-Hui Lin, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 10/995,252

(22) Filed: Nov. 24, 2004

(51) Int. Cl. G09G 5/08

(52) U.S. Cl. 345/167

(57) ABSTRACT

An electronic device having a multi-functional pointing device of a track ball in which a connecting part is arranged through which a shaft is connected so that the shaft is connected to the pointing device of track ball. When the shaft moves and pushes, the pointing device of the track ball swings correspondingly . So the track ball provides different operating interfaces so to alleviate the problem that a user needs to have a different pointing device of a track ball with a different control condition.

### BACKGROUND OF THE INVENTION

1. Field of Invention

The present invention is related to an electronic device, and particularly to an electronic device having a pointing device of a track ball having a shaft connected thereto and thereby having also a function of a joystick.

2. Related Art

Generally, a pointing device is often an indispesnsable device for a user in manipulating an electronic device such as a computer. Of the pointing devices for the existing electronic devices, a touchpad, a track point, a track ball, a joystick and the like are mostly used. Since each of the pointing devices has its particular operating interface, a user may select an appropriate pointing device according to the associated control condition. For example, through the use of a touchpad, a track point and a track ball as the pointing device, the operating interface corresponding thereto may lead to a slower shift speed and lesser shift amount of a pointer. The pointing device operates provided by the electronic device. Therefore, these pointing devices are often used for control of a “select” function provided by the electronic device. In case ajoysrick is used as the pointing device, the pointer provided by the electronic device has a faster and larger shift. Such a pointing device like the joystick is mostly used for control of a “game” function.

Referring to FIG. 1, using a portable computer having a pointing device of a track ball is schematically illustrated therein. The followings will be dedicated to the descriptions regarding to how a user chooses a desired pointing device for specific control conditions in prior practice. As shown, the portable computer having the pointing device of a track ball comprises a track point 12 and a track ball 14 jointly used as a built-in pointing device The track point 12 and the track ball 14 are often used by the user in manipulating the pointer provided by the computer. In case the user isnot familiar with the use of the chosen pointing device, i.e., the track point and/or the track ball in this case, the user may add the use of an external pointer controlling device 16 such as a mouse as the pointing device for the “select” control on the computer.

However, when a user desires to execute game software on the portable computer and manipulate the pointer on the computer through the bullit-in pointing device, it is usually found that the sensitivity demand of the pointer needed for the game software is not satisfactory met by the control associated with the operating interface, associated with the built-in pointing device. In this case, an external joystick 18 is used for the manipulating of the pointer otherwise.

As may be known from the description above, although such an electronic device provides its particular pointing device, the operating interface associated with the point device may limit the function originally provided by the pointing device. This is inconvenient, since the user is required to choose a desired pointing device according to the specific control conditions. Therefore, how to use a pointing device as originally provided by the computer in different control conditions without problems is the purpose of this invention.

### SUMMARY OF THE INVENTION

In view of the problems encountered in the prior art, it is an object of the present invention to provide an electronic device having a multi-functional pointing device of a ball track. The object is achieved by additionally arranging a connecting part on the pointing device to connect a shaft so that the pointing device may provide a different operating interface and a user may change the current operating interface into a desired one according to the control conditions.

To achieve the object as mentioned above, the electronic device having the multifunctional pointing device of the track ball comprises a main computer and a pointing device of a track ball connected electrically thereto and comprising a connecting part selectively connecting with a shaft. As the shaft moves and pushes, the pointing device of a track ball swings and achieves the purpose of manipulating a pointer provided by the main computer.

The preferred embodiments will be described in detail in conjunction with the accompanying drawings as follows.

### BRIEF DESCRIPTION OF THE DRAWINGS

FIG. 1 is a schematic illustration of a prior electronic divice using a joystick;

FIG. 2 is a schemtatic illustration of the architecture of a first embodiment according to the present invention;

FIG. 3A is a schematic illustration of a connecting part of a first embodiment according to the present invention;

FIG. 3B is a schematic illustration of the connecting part of a second embodiment according to the present invention;

FIG. 3C is a schematic illustration of the connecting part of a third embodiment according to the present invention;

FIG. 4A is a schematic illustration of a shaft of a first embodiment according to the present invention;

FIG. 4B is a schematic illustration of the shaft of a second embodiment according to the present invention;

FIG. 4C is a schematic illustration of the shaft of a third embodiment according to the present invention;

FIG. 4D is a schematic illustration of the shaft of a fourth embodiment according to the present invention;

FIG. 5A is a schematic illustration of a connection between the shaft and the connecting part of a first embodiment according to the present invention;

FIG. 5B is a schematic illustration of the connection between the shaft and the connecting part of a second embodiment according to the present invention;

FIG. 5C is a schematic illustration of the connection between the shaft and the connecting part of a third embodiment according to the present invention;

FIG. 5D is a schematic illustration of the connection between the shaft and the connecting part of a fourth embodiment according to the present invention; and

FIG. 6 is a schematic illustration of a second embodiment according to the present invention.

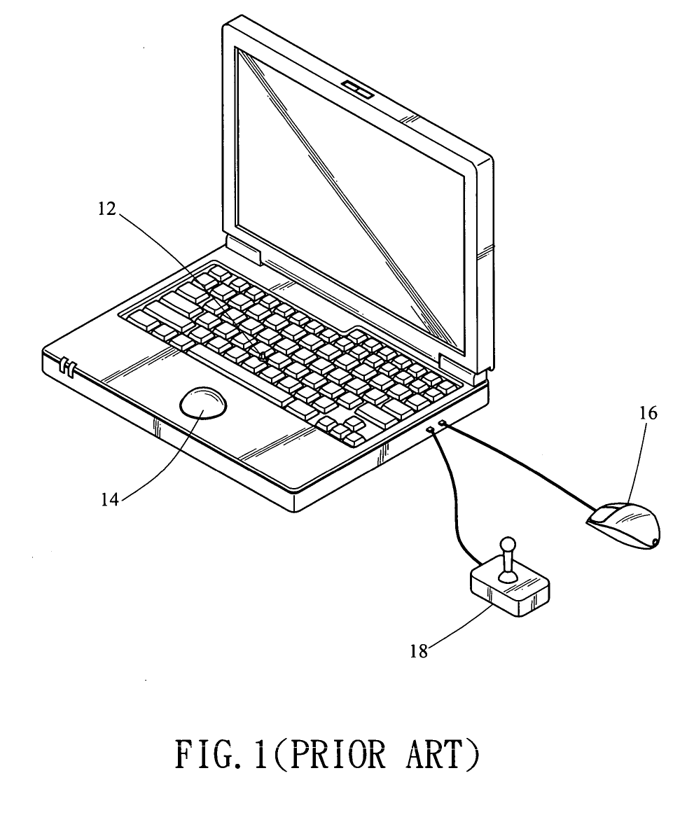

### DETAILED DESCRIPTION OF THE INVENTION

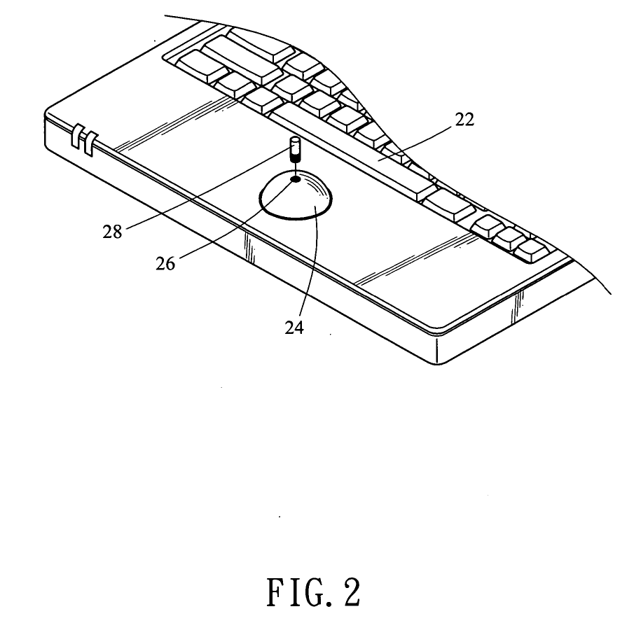

Referring to FIG. 2, a schematic illustration of the architecture of an electronic device of a first embodiment according to the present invention is provided. In this embodiment, a portable computer is used as the implementation of the electronic device. The portable computer comprises a pointing device of a track ball 24 and a main computer 22 electrically connected thereto. The pointing device of a track ball 24 is equipped with a connecting part 26, which may be connected to a shaft 28. According to a manipulation by a user, an associated swing is presented on the pointing device of the track ball 24. According to a direction of the swing, a pointer presented on an operating system (OS) in the main computer 22 has a corresponding shift.

For the connection of the shaft 28 with the connecting part 26 connected to the pointing device of a track ball 24, a lock, a tenon and a screw, for example, may be used. Once the shaft 28 is connected to the pointing device of the track ball 24 through the connecting part 26, the pointing device of the track ball 24 has a swing thereon through moving and pushing of the shaft 28. The implementation of and connection between the connecting part 26 and shaft 28 is expained in detail as follows.

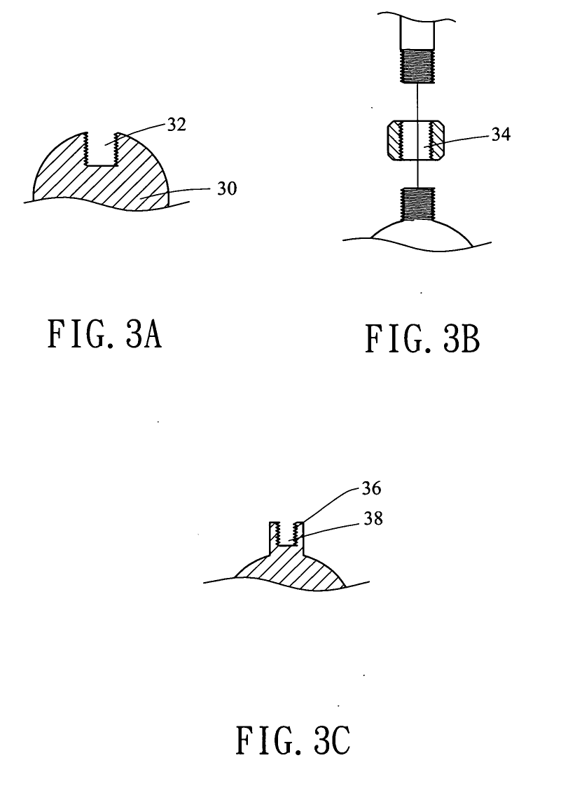

Referring to FIGS. 3A-3C, possible embodiments of the connecting part acording to the present invention are set forth as particular examples therein. In FIG. 3A, the pointing device of a track ball illustrated therein may be a pointer controller having a roller or a rolling ball such as a traack ball 30. In the case the track ball 30 as the pointing device of track ball, the connecting part 32 may be an depression arranged on the track ball 30.

Referring to FIG. 3B, when a track point is used as the track ball, the connecting part 34 may be designed as a locking member connected between the track point and a shaft-like member and the locking member may be a screw or a sleeve. Also shown in FIG. 3B, the connecting part may also be a depression 38 on the shaft-like member.

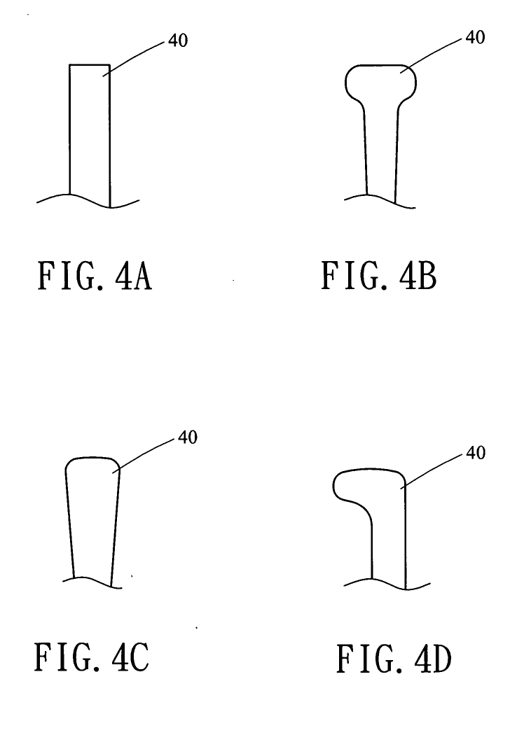

Referring to FIGS. 4A-4D, embodiments of the shaft according to the present invention are schematically illustrated therein. As shown, the shaft 40 may be used as long as it may be hold and pushed by a user without any limitation of its shape and dimension.

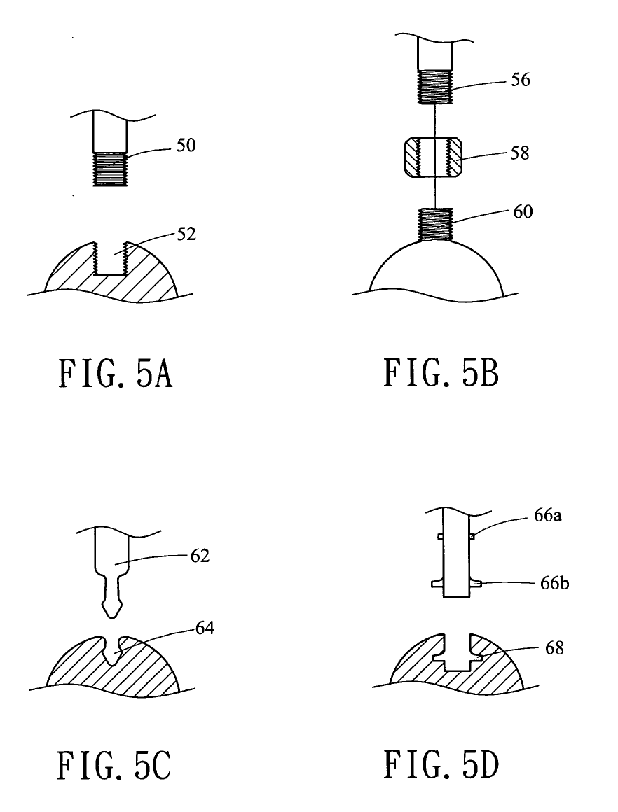

Referring to FIGS. 5A-5D, embodiments of connection forms between the shaft and the pointing device of the track ball according to the present invention are schematically illustrated therein. In FIG. 5A, 5B, 5C and 5D, the first, second, third and fourth embodiments are shown respectively.

Referring to FIG. 5A, the shaft 50 is connected to the pointing device of the track ball through the connecting part 52, by arranging an exterior thread at the bottom of the shaft 50 and an interior thread inside the connecting part 52. By locking the screw and the thread, the shaft 50 is fixed into the connecting part 52.

Referring to FIG. 5B, a fixing member 58 connects the shaft 56 to the pointing device of track ball. In this case, the fixing member 58 serves as the connecting part. Specifically, the pointing device a track ball is arranged with a shaft-like member 60 and the fixing member 58 is a screw or sleeve having a thread. An exterior screw may be disposed at the bottom of the shaft 56 and the top of the shaft-like member 60 Then the fixing member 58 is locked and fixed at the top of the shaft-like member 60 and the bottom of the shaft 56 within the fixing member 58, thereby connecting the shaft 56 to the pointing device of track ball.

Reffering to FIG. 5C , the shaft 62 has a bottom which is engaged with and fitted in the connecting part 64 of the pointing device of the track ball, so that the shaft 62 may be connected with the connecting part 64 through an appropriate force .

Referring to FIG. 5D, the shaft has a press part 66a and a tenon 66b and the pointing device has a fastener 68 at the connecting part. The tenon 66b may be induced with a buckling-and-closing action based on transmission from the press part 66a, and connected to the fastener 68.

In addition, the connecting part for the above connection between the shaft and pointing device according to the third and fourth embodiments may be arranged on the shaft-like member.

The connection of the connecting part between the pointing device of the track ball and the shaft may not be particularly limited as long as the shaft connected to the pointing device of the track ball is subject to a force and pushes outwards. The pointing device of a track ball swings correspondingly.

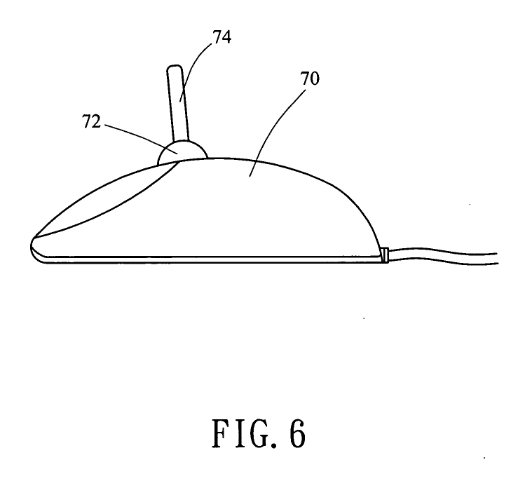

Next, an electronic device other than the portable computer as mentioned above is taken as a second embodiment of the present invention. Referring to FIG. 6, a pointer-controlling device, i.e., a mouse is used as an electronic device. As shown, the pointer-controlling device 70 has a pointing device of a track ball 72, e.g. a track ball or roller. In the pointer-controlling device 70, a shaft 74 is arranged onto the pointing device of a track ball 72 in the same manner as described above. Therefore, a user only need to fix the shaft 74 onto the pointer controlling device 70 and the pointer controlling device 70 is used as a joystick. In this case, an external joystick is not required..

In all, the user may enable the pointing device of the track ball to swing as transmission from the shaft. Therefore, the shaft according to the present invention controls or manipulates the pointer displayed on the operating system in the electronic device and thus provides a variety of operating interfaces.

The embodiments as decribed are deemed as mere preferred ones according to the present invention and not limitative of the scope and spirit of the present invention. Any modification or change of the present invention should be encompassed by the claims recited as follows.

What is claimed is:

1. An electronic device having a multi-functional pointing device of a track ball comprising a main computer and a pointing device of a track ball electrically connected thereto, characterized in that the pointing device of a track ball has a connecting part through which a shaft is connected and the pointing device swings through a transmission from the shaft.

2. The electronic device as recited in claim 1, wherein the shaft is connected to the connecting part by a fastener.

3. The electronic device as recited in claim 1, wherein the shaft is connected to the connecting part by a screw.

4. The electronic device as recited in claim 3, wherein the shaft has an exterior screw at a bottom and the connecting part has an interior screw for locking and fixing thereto.

5. The electronic device as recited in claim 1, wherein the shaft is connected to the connecting part by a tenon.

6. The electronic device as recited in claim 5, wherein the shaft has at least one tenon(s) at a bottom and the connecting part has at least one fastener for locking and closing thereto.

7. The electronic device as recited in claim 5, wherein the shaft has a fastener at a bottom and the connecting part has the tenon locking and closing thereto.

8. The electronic device as recited in claim 1, wherein the connecting part is a depression on the pointing device of track ball.

9. The electronic device as recited in claim 1, wherein the connecting part is a fixing member on the pointing device of track ball.

10. The electronic device as recited in claim 1, wherein the fixing member is a screw.

11. The electronic device as recited in claim 1, wherein the connecting part is a shaft-like member when the connecting part protruding on a track point.

12. The electronic device as recited in claim 11, wherein the connecting part is the shaft-like member when the connecting part protruding on a track point.
